(19) United States
(12) Patent Application Publication
(10) Pub. No.: US 2017/0171141 A1
(43) Pub. Date: Jun. 15, 2017

(54) APPLICATION FOR FACILITATING INTRODUCTIONS

(71) Applicant: Connector Street Inc., Wilmington, DE (US)

(72) Inventor: Andrea Tinianow, Wilmington, DE (US)

(21) Appl. No.: 15/377,313

(22) Filed: Dec. 13, 2016

Related U.S. Application Data
(60) Provisional application No. 62/266,956, filed on Dec. 14, 2015.

(51) Int. Cl. H04L 12/58; G06Q 50/00; G06Q 20/06; H04L 29/08

(52) U.S. Cl. CPC H04L 51/32; H04L 51/04; H04L 67/02; H04L 67/306; H04L 51/08; H04L 51/34; G06Q 50/01; G06Q 20/0658

(57) ABSTRACT

Facilitating online introductions on a computing device can involve an introducer who selects two contacts to introduce. The introduction includes an indication of the type of relationship that the introduction could lead to and a message from the introducer. Each contact's contact information is forwarded to the other contact. The contacts can choose to communicate with one another at the suggestion of the introduction.

### RELATED APPLICATION(S)

This patent application claims the benefit of U.S. patent application Ser. No. 62/266,956 filed on Dec. 14, 2016, the entirety of which is hereby incorporated by reference.

### BACKGROUND

In the online environment, there are web sites that assist users in making social and business connections. Social media and social networking services are abundant. An individual can connect with many other people and keep a collection of contacts in each account. Additional contacts may be suggested based on the individual's current contacts or other automated criteria such as following the same issues or liking the same companies. However, something can be lost in the sea of people and options provided on those sites—the personal touch of connecting two mutual acquaintances.

### SUMMARY

Embodiments of the disclosure are directed to a method of facilitating online introductions implemented on a computing device, the method comprising: receiving a selection from a user of a first contact and a second contact to create an introduction; receiving a selection from the user of a relationship type for the introduction; and sending an invitation to the first and second contacts to make the introduction.

In another aspect, a computing device is described comprising a display; a processor; and memory encoding instructions that, when executed by the processor, cause the processor to: access a plurality of contacts associated with a user; allow for selection of two contacts to introduce; allow for a definition of a relationship type between the two contacts; and forward an introduction to each of the two contacts

In yet another aspect, a system programmed to facilitate introductions is described, the system comprising: a display; a processor; and memory including instructions that, when executed by the processor, create: a profile module programmed to set up a profile for a user; a contact module programmed to assemble a plurality of contacts associated with the user; an introduction module programmed to select two contacts to make an introduction and to receive a selection of a relationship type; and a communication module programmed to communicate an invitation to the two contacts to make the introduction.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for facilitating introductions implemented on a computing device.

FIG. 2 shows example modules of the computing device in FIG. 1.

FIGS. 3A-3C show example displays of a splash screen on a graphic user interface displayed of the computing device of FIG. 1.

FIGS. 4A-4B show example displays of a login page on the computing device of FIG. 1.

FIG. 5 shows an example display of a profile setup page on the computing device of FIG. 1.

FIG. 6 shows an example display of a dashboard on the computing device of FIG. 1.

FIG. 7 shows an example display of an introduction page on the computing device of FIG. 1.

FIG. 8 shows another example display of the introduction page of FIG. 7.

FIG. 9 shows yet another example display of the introduction page of FIG. 7.

FIGS. 10A-10C show alternative examples of displays of the introduction page of FIG. 7.

FIG. 11 shows an example display of an invitation on an email interface.

FIG. 12 shows an alternative example display of the invitation of FIG. 11 on a web browser interface.

FIG. 13 shows an example display of an email message.

FIG. 14 shows another example display of an email message on the computing device of FIG. 1.

FIG. 15 shows an example display of an introductions page on the computing device of FIG. 1.

FIG. 16 shows another example display of the introductions page of FIG. 15.

FIG. 17 shows an example display of a connections page on the computing device of FIG. 1.

FIG. 18 shows an example display of a profile page on the computing device of FIG. 1.

FIG. 19 shows a flowchart for an example method of facilitating online introductions implemented on a computing device.

FIG. 20 shows example physical components of the computing device of FIG. 1.

### DETAILED DESCRIPTION

The examples described herein relate to a software application, such as those executed by a smartphone or computing device for mobile platforms like Apple's IOS and Google's Android, that facilitates online introductions. Individuals use the software application to introduce two contacts to each other.

For example, an individual might be friends with two people who are not acquainted with each other, but have similar business interests. The individual could access a software application, select those two people to meet, and the software would prompt the two people to accept an invitation to be introduced to each other by exchanging contact information online.

The individual could use existing social networking applications to aid in gathering contact information for people that the individual knows. That contact information is then exchanged between two people that the individual wishes to introduce to each other for business, social, or romantic reasons. This adds a personal touch because the individual is making the introduction instead of an automated system, and the individual can determine the best reason for the two people to meet based on the individual's knowledge of the people.

In addition to the benefits of the personal touch, the systems and methods described have the technical benefit of communicating contact information to chosen individuals in a more efficient manner. Typically to share contact information with another person, an individual would have to locate and access the contact information, copy the information, and then select a method of communicating the information to the person. A computing device can perform fewer functions, thereby freeing up memory for other applications, by simply accessing contact information and communicating it directly to the individuals being introduced.

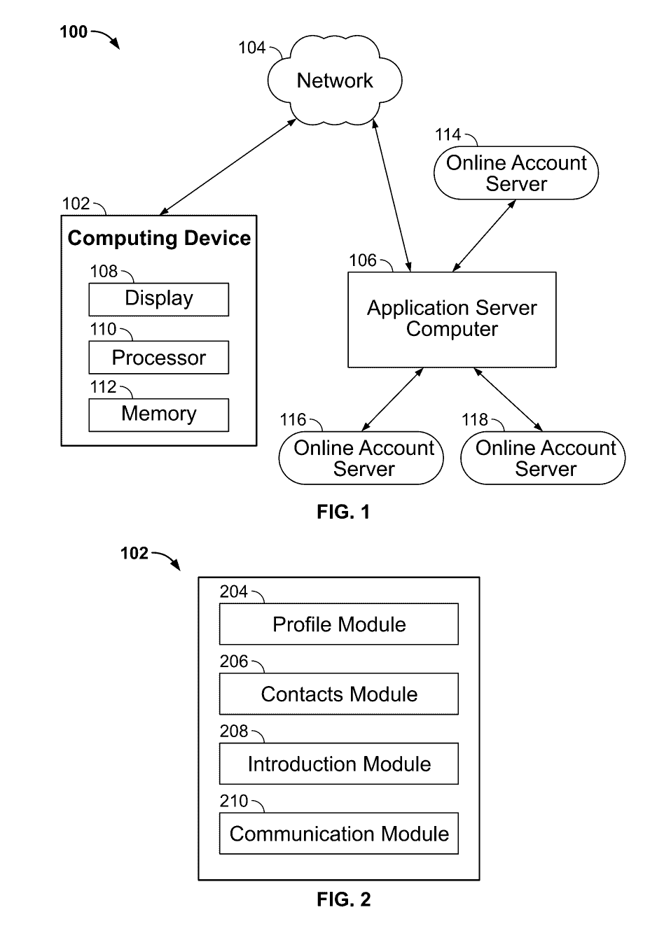

FIG. 1 illustrates an example system 100 for facilitating online introductions. The example system 100 includes a computing device 102, a network 104, and an application server computer 106.

The example computing device 102 includes a display 108, a processor 110, and memory 112. The display 108 is a visual display such as a screen that is built-in to the computing device 102. The processor 110 has wireless capability. The wireless capability may include Bluetooth, radio frequency identification (RFID) or similar types of wireless capability. The memory 112 includes computer readable instructions that may include computer readable storage media and computer readable communication media.

The computing device 102 communicates with a network 104 that, in turn, communicates with an application server computer 106. The network 104 may be a wireless “cloud network” which the computing device 102 communicates with via the processor 110. The computing device 102, network 104, and server may be connected in other ways, such as a hard wired connection. The application server computer 106 is associated with one or more online account servers 114, 116, 118.

FIG. 2 shows a schematic block diagram of example modules that are created when the processor 110 executes instructions stored in the memory 112 of the computing device 102 of FIG. 1. Example modules include a profile module 204, a contacts module 206, an introduction module 208, and a communication module 210.

The profile module 204 is programmed to set up a profile for a user. The profile can include the user's name, an email address, a phone number, a social networking account, a photograph of the user, and a website associated with the user. The profile may also include preferences for the user, including indicating whether the user wishes to be introduced to other users or prefers to only make introductions. The profile module 204 also records introductions made by the user and records connections to new contacts that the user has made as the result of an introduction made by other users.

The profile module 204 may also record ratings of introductions provided by contacts and/or rank the users based on how many introductions the user has made. The profile module 204 may send automated messages to users to notify the users of their ranking.

The contacts module 206 is programmed to assemble a plurality of contacts associated with the user. Contacts may be stored locally on the computing device 102. Contacts may also be accessed from online accounts which may include email accounts and social networking accounts. Examples of such online accounts include Outlook, Google, Facebook, LinkedIn, and Twitter. The names of contacts are assembled into a list and the associated contact information is accessed upon selection of one or more contacts from the list.

The introduction module 208 is programmed to allow for the user to select two contacts to make an introduction. The introduction module 208 is further programmed to receive a selection from the user of the type of relationship the introduction should lead to. Relationship types may include social/personal, business/professional, and romantic/dating. The introduction module 208 also allows for a user to include a personal message with an introduction.

The communication module 210 is programmed to communicate an invitation to the two contacts to accept or reject the introduction. Using the contact information obtained through the contacts module 206, the communication module 210 invites the selected contacts to make the introduction. The invitation may be sent through a smartphone application, email, instant messaging, text messaging, or other communication schemes.

The invitation may indicate the identity of the user who made the introduction. The invitation may include a photo and a name of the person to which the contact is being introduced. The communication module 210 takes the contact information obtained from the contacts module 206 and relays that information to each selected contact.

In some optional embodiments, the communication module 210 may request that the contacts consent to the introduction before contact information is relayed to each contact. If the communication module 210 receives input from one or both of the contacts to decline the introduction, the transfer of contact information will be blocked. The communication module 210 may also notify the user of successful and unsuccessful introductions through a text message, a notification on a smartphone application, email, or other communication scheme.

The exemplary modules of the computing device shown in FIG. 2 can be implemented as one or more software applications. Users interact with the software application on a computer, a tablet, or a smartphone by viewing a graphic user interface and providing input to the computing device through a touchscreen, keyboard inputs, mouse inputs, or other inputs.

Users may download the software application from an online store such as Google Play or the Apple App Store. Upon downloading and installing the software application, a message may be generated prompting the user to make an introduction, such as: “Do not delay, make an introduction right now!”

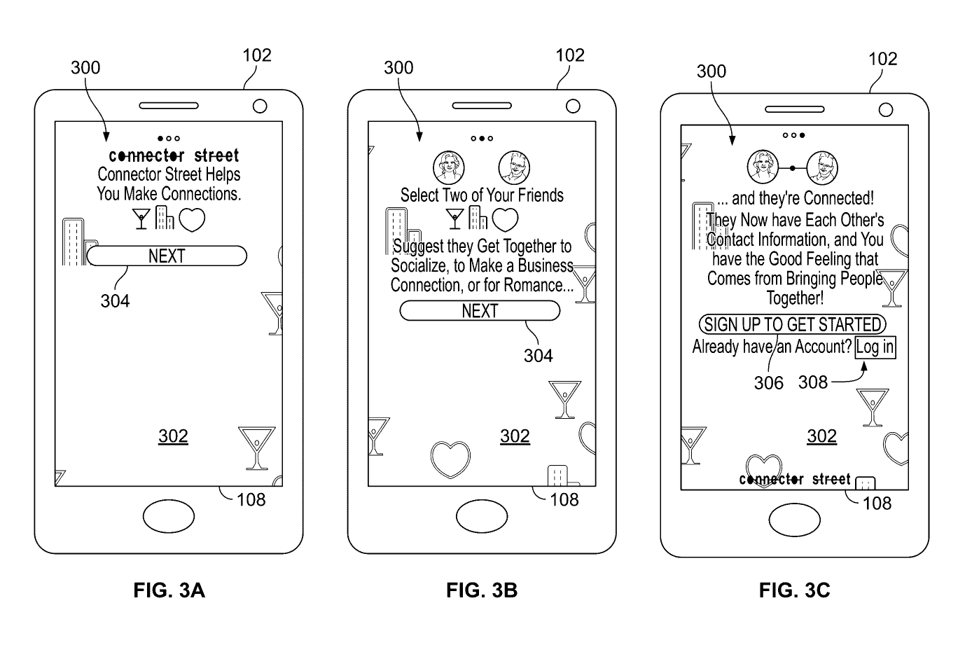

In one example, the software application includes a splash screen 302 when started, as shown on the display 108 in FIG. 3A. The splash screen 302 is an example graphical user interface 300 generated by a computing device 102, like a handheld device (e.g., smartphone or tablet), laptop, desktop, etc.

As a user continues to interact with the software application, for example by selecting a “next” button 304 as shown in FIG. 3A, the splash screen 302 in FIG. 3A proceeds to explain how the software application works, as shown in FIG. 3B. A user can continue by selecting the “next” button 304 yet again.

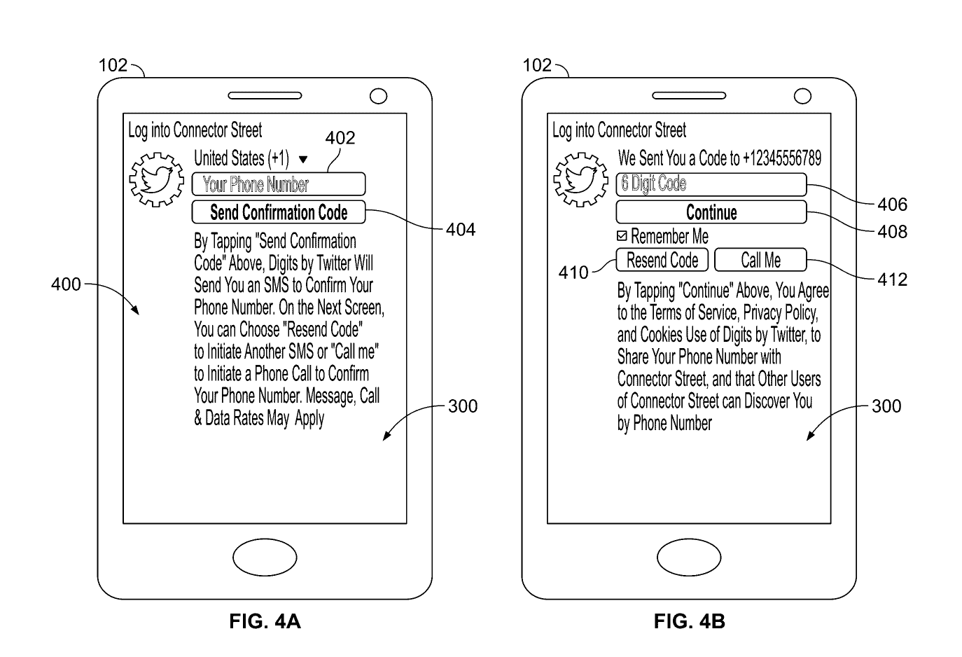

In FIG. 3C, the splash screen 302 includes a signup button 306 which links to a registration page. If the user is already registered, he or she may select the login link 308 to access a login page, such as the login page 400 displayed on the graphical user interface 300 in FIG. 4A.

In FIG. 4A, the computing device 102 is displaying a login page 400 having a phone number field 402 and a “send confirmation code” button 404. Upon entering the user's cell phone number and selecting the “send confirmation code” button 404, the login page 400 presents a code entry field 406 in which the user enters the unique confirmation code that was sent to the user via text massage. Upon entry of the code, the user selects the “continue” button 408 to submit the confirmation code and continues with registration. Alternatively, the user can select the “resend code” button 410 to be sent a different confirmation code or the “call me” button 412 if the user wishes to receive the confirmation code via phone call.

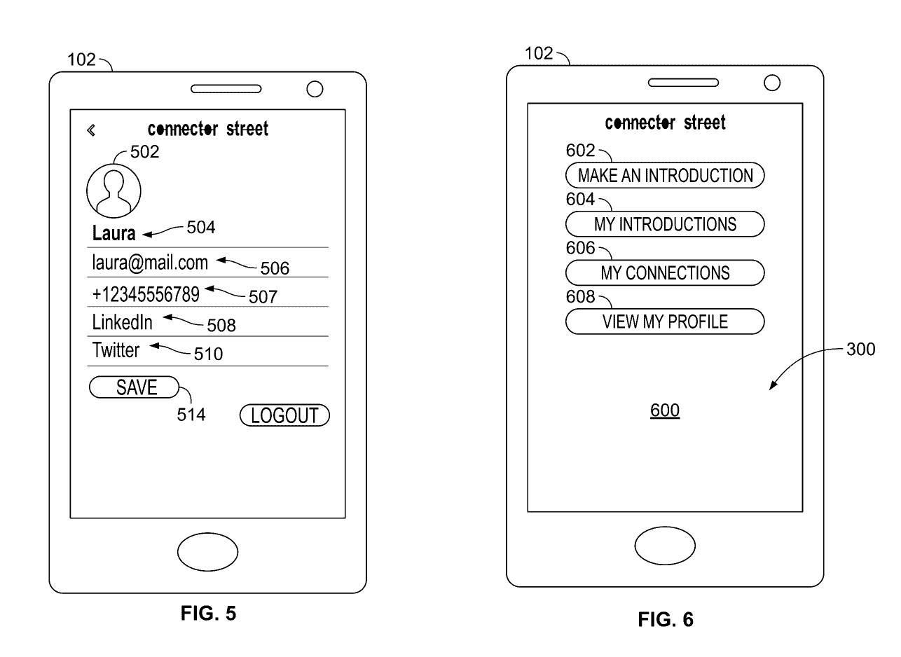

Upon entry of the confirmation code, the graphical user interface 300 displays a profile setup page 500, as shown in FIG. 5. In the profile setup page 500 displayed on the computing device 102, a user may upload a photo by selecting the profile photo button 502. There are also fields for the user to enter a name 504, an email address 506, a phone number 507, and one or more online accounts 508, 510. The user may also provide a website address associated with the user. The profile setup page 500 may also include a preferences selector indicating whether the user wants to only make introductions, or allow for introductions from anyone. Once the user has entered the desired profile information, the user can select the save button 514. In some examples, the profile information can be pre-populated based upon information cached on the computing device.

FIG. 6 shows an exemplary dashboard 600 displayed on the graphical user interface 300 on the computing device 102 of FIG. 1. The dashboard 600 is displayed once a user has set up a profile. The dashboard 600 is displayed upon logging into the software application and includes the following selections: a “make an introduction” button 602, a “my introductions” button 604, a “my connections” button 606, and a “view my profile” button 608. These selections are described further in reference to the following figures.

Upon selecting the “make an introduction” button 602 in FIG. 6, the graphical user interface 300 displays an introduction page 700. A user selects a first contact 702 and a second contact 704 for an introduction. The user, as the introducer, also specifies a relationship type for the introduction by selecting one of the options in the relationship type selector 706.

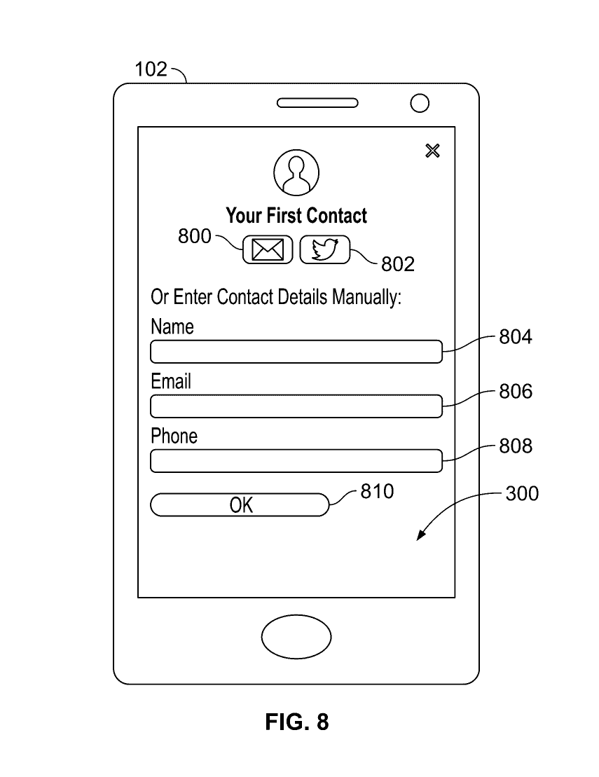

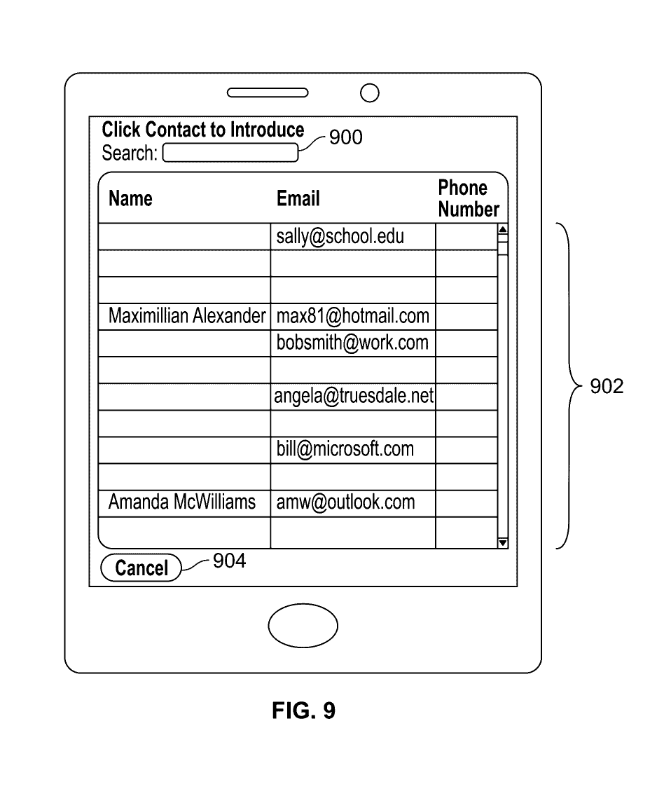

Upon selecting the icon for the first contact 702, a pop-up window or a new page will appear, as shown in FIG. 8. Online account icons 800, 802 are displayed at the top of the graphical user interface 300. In this example, one online account icon 800 is for a Gmail account and the other online account icon 802 is for a Twitter account. Other examples of online accounts include Outlook, Facebook, and LinkedIn. Clicking on either icon will open a new window or page, as shown in FIG. 9. Alternatively, the user could manually enter contact information into the name field 804, email field 806, and phone field 808 and select the “ok” button 810 to continue.

FIG. 9 shows a new window or page which is presented upon selecting an online account icon 800, 802, such as those shown in FIG. 8. Selection of the icon selects a corresponding online account associated with the user/introducer. In this example, the Gmail online account icon 800 has been selected and the user's contacts 902 from that account are displayed. Each contact's contact information may be displayed as well. The contact information may include an email address, a social network username, a phone number, or a website. At the top of the page, a search box 900 is displayed to quickly find contacts within the list. The user selects one of the contacts 902 or can select the cancel button 904 to return to the previous page. This process is repeated to select a second contact.

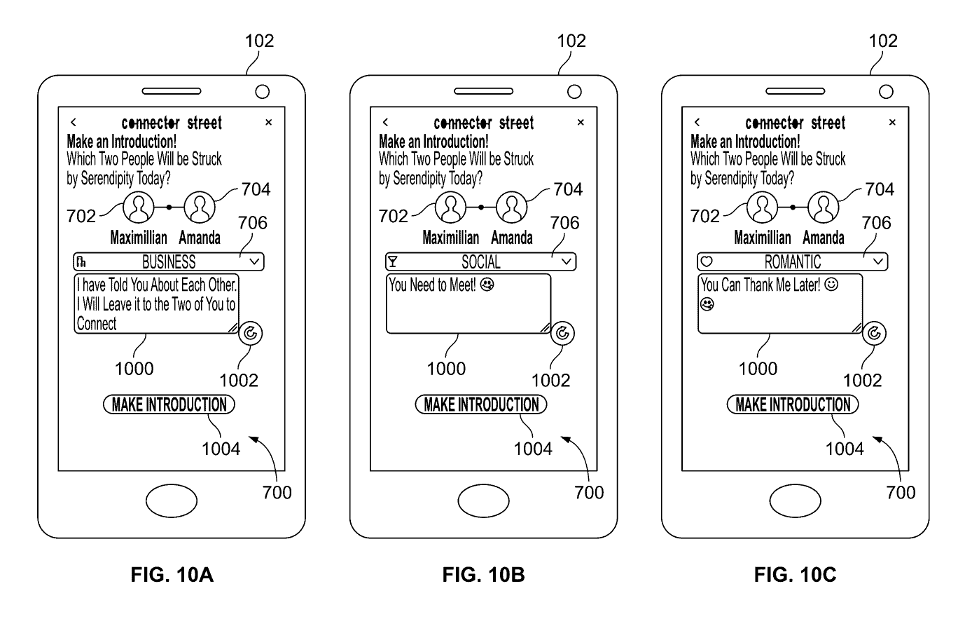

FIGS. 10A-10C show the introduction page 700 after the first contact 702 and the second contact 704 have been selected. FIG. 10A shows the introduction page 700 when the relationship type selector 706 is chosen for “business.” A user/introducer may select a “business” relationship, for example, if the user wishes to introduce two people that could form a mutually beneficial business relationship with one another. FIG. 10B shows the introduction page 700 when “social” is selected. A user may select this relationship type if the user thinks that two people he or she knows would enjoy being friends due to mutual interests. FIG. 10C shows the “romantic” selection, which a user may use to introduce two people that the user thinks should date.

In all of the examples of FIGS. 10A-10C, a message 1000 is displayed. The message 1000 may be generated automatically or the user can replace it with personalized text. If the user would like to display a different automatically generated message 1000, the user can select the refresh button 1002. In some embodiments, the user/introducer can select an option to remain anonymous to the contacts when the introduction is made. Once the user/introducer has selected a first contact 702, a second contact 704, a relationship type selector 706, and a message 1000, the user selects the “make introduction” button 1004 to submit an introduction invitation to the first and second contacts.

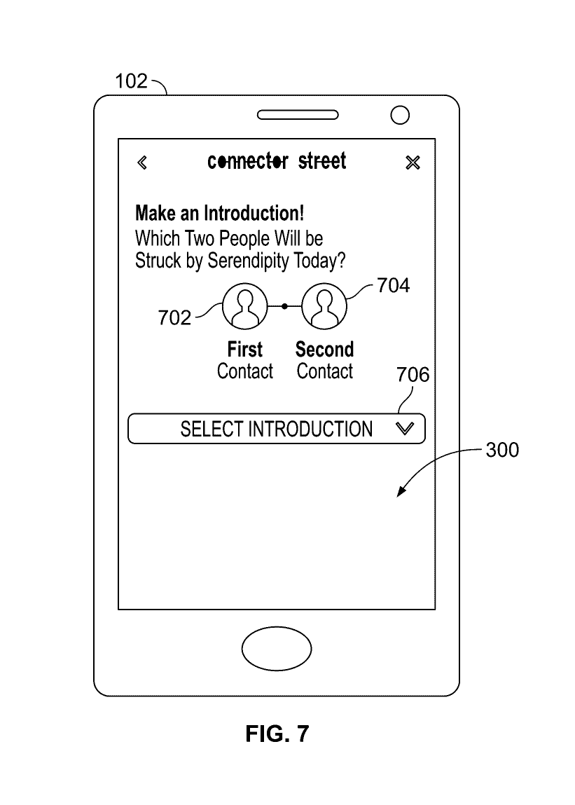

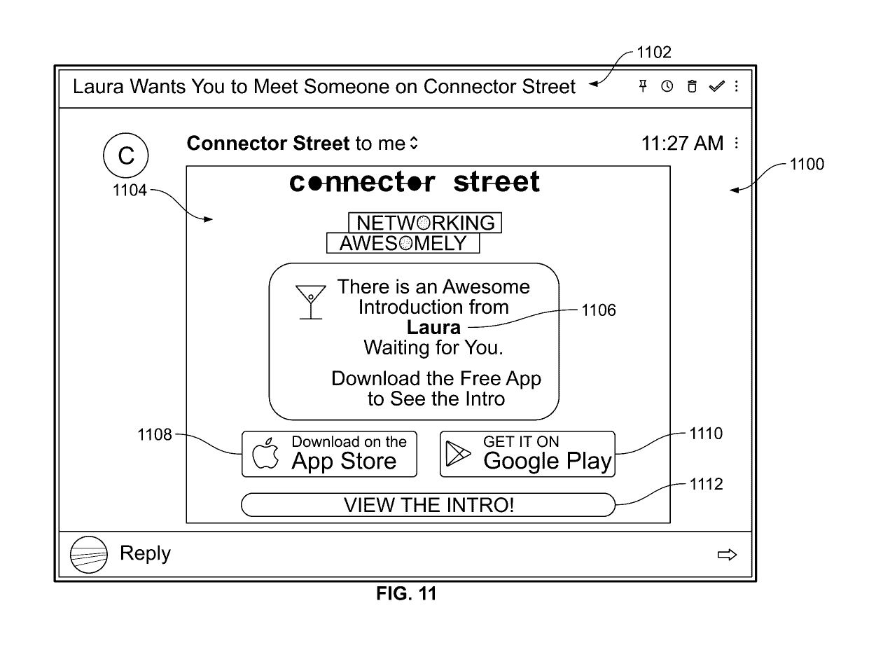

FIG. 11 shows an example of an invitation 1104 as seen on an email graphic user interface 1100. This invitation 1104 is received by the first contact described in FIGS. 6-10. Here, an email with the subject 1102 (“Laura wants you to meet someone on connector street”) is received by the first contact. The invitation 1104 includes the name of the user/introducer 1106 as well as a link 1108 to download the software application on the Apple App Store, a link 1110 to download the software application on the Google Play store, and a link 1112 to view the introduction in a webpage. In instances where the user/introducer wanted to remain anonymous, the user's name would not be displayed on the invitation.

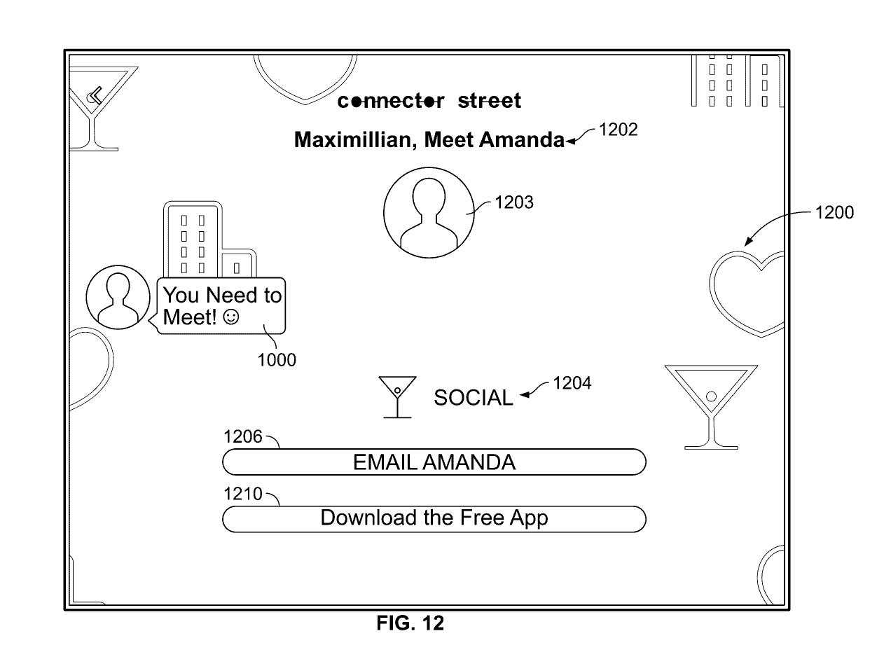

The invitation may include a photo of the user, if the user is not anonymous, along with a name and photo of the second contact. The invitation may also include a personal message from the user/introducer. Upon downloading the software application, the invitation would be displayed to the first contact. Alternatively, upon selecting the link 1112 to view the introduction in a webpage, the introduction would be displayed as shown in FIG. 12.

FIG. 12 shows an example of an introduction page 1200 which includes the names of the first and second contacts 1202 and a profile picture of the second contact 1203. A relationship type indicator 1204 shows that this introduction is for a social relationship and the message 1000 from the user/introducer is displayed. The first contact can select a communication button 1206 to communicate with the second contact via email. There is also a link 1210 to download the software application.

In some embodiments, if the first contact elects to download the software application, the first contact will see a connection confirmation page displayed on the computing device 102 when the software application is first initiated. The connection confirmation page may include the name of the second contact, the second contact's photo, and the second contact's contact information. The contact information may be displayed as links so that an email address will open an email, a phone number will start a call, and a web address will open a web page. Alternatively, the contact information may simply be displayed without links.

In some embodiments, a rating page may optionally be displayed requesting the first contact to rate the user/introducer. The rating page may include a profile picture of the user/introducer, the name of the user/introducer, a rating selector, and a “submit” button. This rating may be reflected in the introducer's profile so that future individuals that are being introduced by the introducer can see the introducer's rating before deciding to accept or decline an invitation.

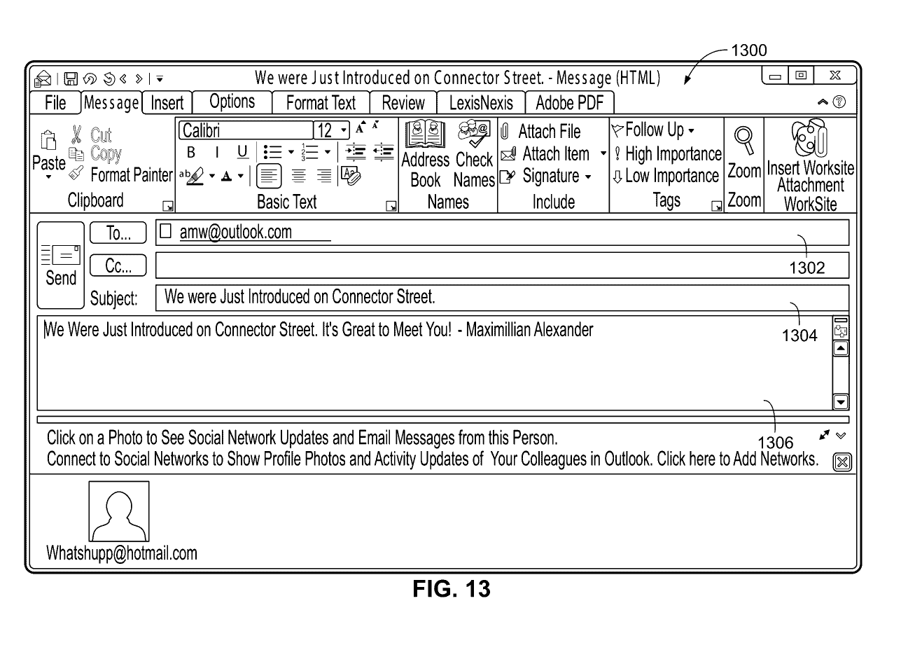

If the first contact elects to communicate with the other contact, he or she may select the communication button 1206 in FIG. 12, which will open an email message to the other contact. An example of such an email message 1300 is shown in FIG. 13. The email message 1300 may be pre-populated with the other contact's email address 1302, a subject 1304, and a message 1306. The first contact may change the subject or email message before sending the email 1300 to the other contact.

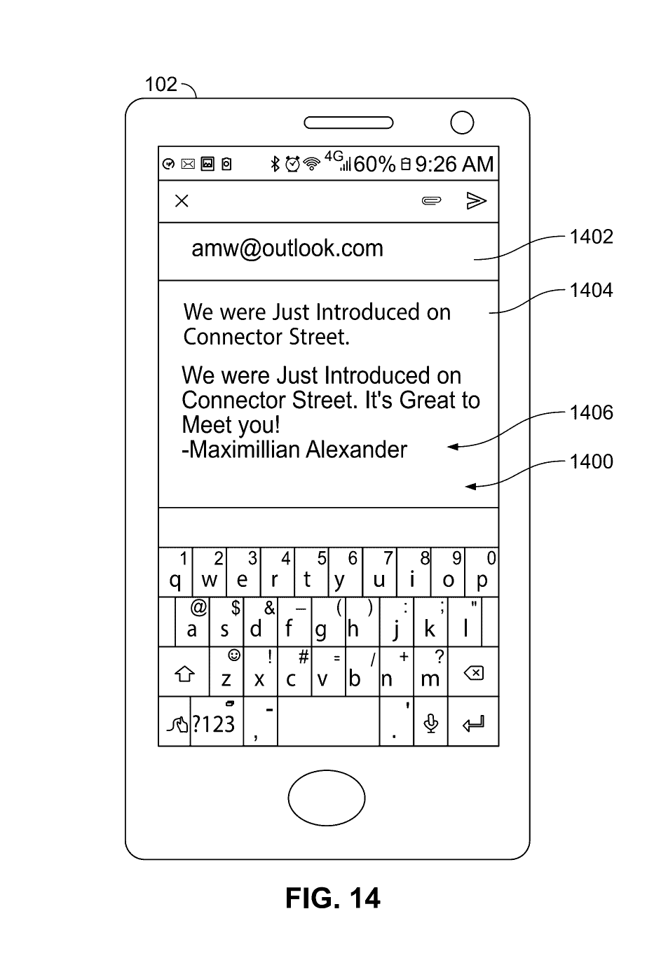

FIG. 14 displays an alternate email message 1400 displayed on the computing device 102. The email message 1400 may again be pre-populated with the other contact's email address 1402, a subject 1404, and a message 1406. In an alternative embodiment, invitations may be sent to contacts via text message. Here, an invitation text message is sent to the first contact, which may provide the name of the user/introducer, the name of the second contact, the type of relationship, and a link to view the introduction. The first contact can accept the invitation by responding with a “yes” text message. Alternatively, the first contact could decline the invitation by responding with a “no” text message. As noted above, such consent by each introduced party is not necessary in some embodiments. In other words, the invitation may not request for the contact to accept or decline the introduction.

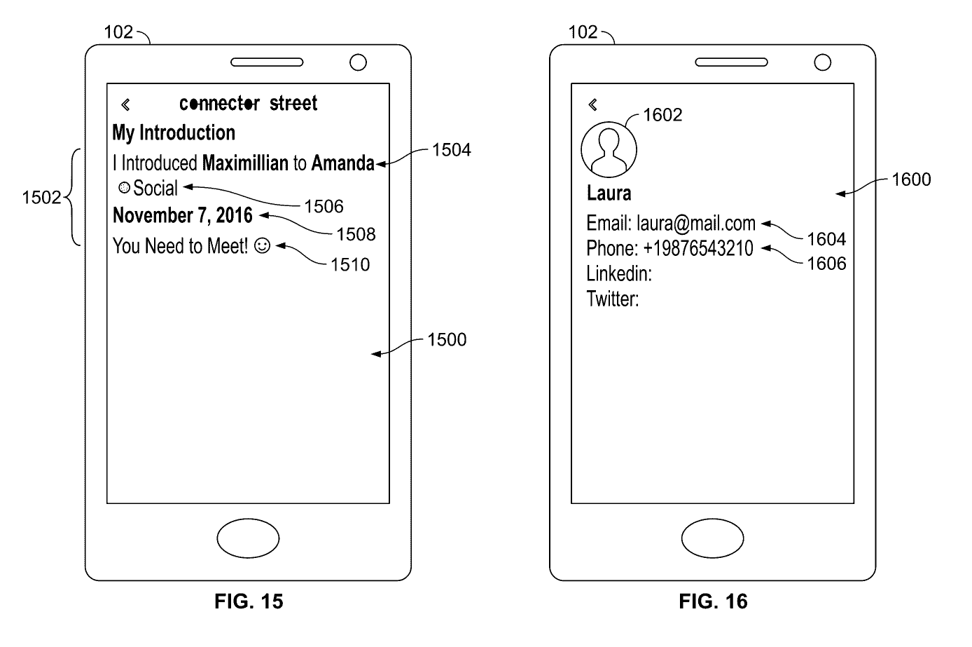

FIG. 15 shows a “my introductions” page 1500 that is displayed when the user selects the “my introductions” button 504 on the dashboard 600 of FIG. 6. Introductions 1502 that the user has made are displayed and include the names of the contacts introduced 1504, the type of relationship 1506, the date of the introduction 1508, and the message sent with the introduction 1510. This can be useful, for example, if the user wants to reacquaint him/herself with previous introductions that the user has initiated.

If the user clicks on one of the names of the contacts introduced 1504, the contact information for that contact may be displayed as shown in FIG. 16. A contact page 1600 may include a photo 1604 of the contact, the contact's name 1604, and contact information 1606 for the contact. The contact information 1606 may include links so the user can communicate with that contact.

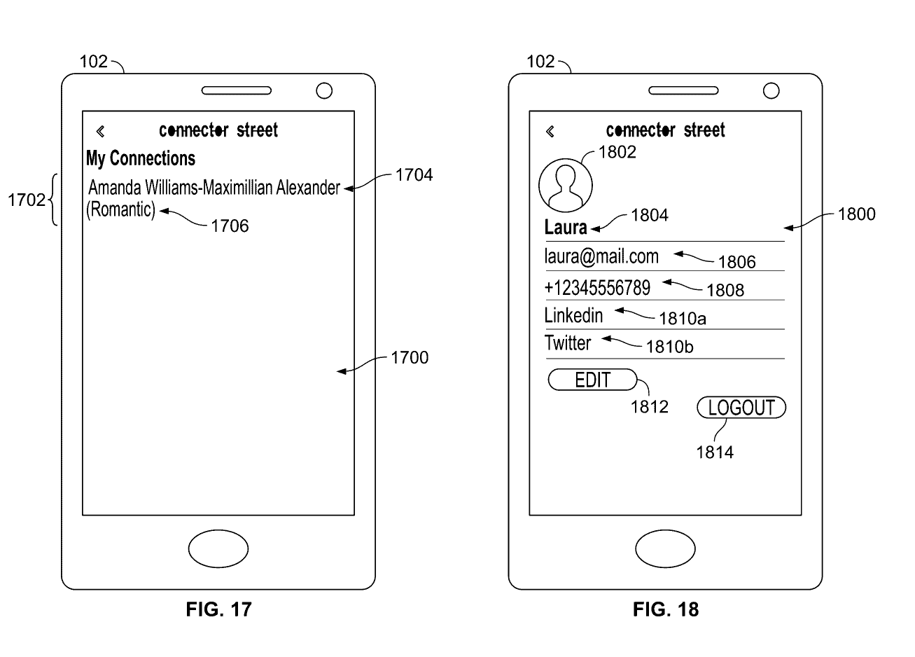

FIG. 17 shows a “my connections” page 1700 that is displayed when a user selects the “my connections” button 606 on the dashboard 600 of FIG. 6. One or more connections 1702 that the user has made by receiving introductions from other users are displayed. Each connection 1702 includes the names 1704 of the contact and the introducer, the type of relationship 1706, and may optionally include a rating for the introduction. In this example, connection 1702 involved Amanda Williams and Maximillian Alexander for a romantic relationship. The “my connections” page may be useful if the user wants to look up contacts he or she met through the application. The list of connections may include hyperlinks to each connection's contact information. Upon selecting a hyperlink, the text may change in appearance. For example, bold text may change to normal text after selecting a connection.

FIG. 18 shows a profile page 1800 that is displayed when a user selects the “view my profile” button 608 on the dashboard 600 of FIG. 6. The profile page 1800 shows the user's profile picture 1802, name 1804, email address 1806, phone number 1808, and linked social media and online accounts 1810a, 1810b. The user can edit his or her profile by selecting the “edit” button 1812. The user can logout of the software application by selecting the “logout” button 1814.

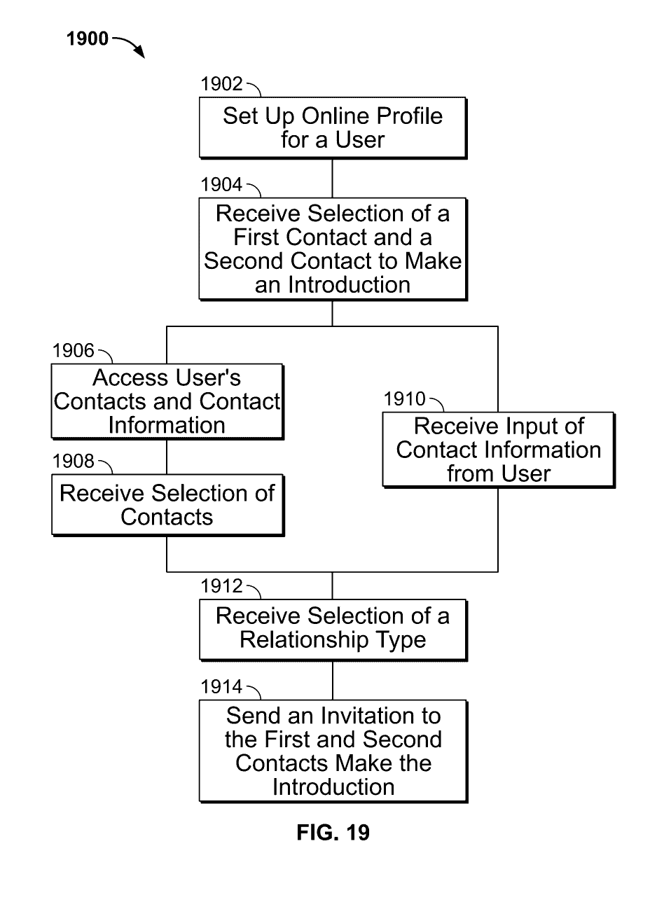

FIG. 19 shows a flowchart of a method 1900 implemented on a computing device, such as the computing device 102, for facilitating online introductions.

At operation 1902, an online profile for a user is set up. The profile includes the user's name and at least one of an email address, a phone number, and an online account. The profile may also include a photograph of the user and a website associated with the user. The user may also set up preferences, which may include indicating whether the user wishes to be introduced to other users or prefer to only make introductions.

At operation 1904, a selection is received from the user of a first contact and a second contact which the user wishes to introduce to each other. The contacts may be selected by manual input or by choosing from contacts associated with the user.

At operation 1906, the software application accesses contacts associated with the user. Contacts may be accessed in the memory 112. Contact information in the memory 112 may have been previously entered into the computing device by the user. Alternatively, the contact information may have been downloaded from an external source. In addition, contacts may be accessed from one or more online accounts associated with the user. The user may be prompted to log into the online accounts or the application may already have access to the user's online accounts. The online accounts may include social media networks and email accounts.

At operation 1908, the user selects the contacts that the user wants to introduce. The contact information for those contacts is accessed from the device memory or the online accounts of the user.

An alternative method of selecting contacts is described at operation 1910. Here, the user simply inputs the name and contact information of the contact he or she wishes to introduce to another contact.

Regardless of the method of input, once the first contact and second contact are selected, the user selects a relationship type at operation 1912. The relationship type is selected from a business relationship, a social relationship, and a romantic relationship. Other relationship types are possible.

At operation 914, an invitation is sent to the first contact and the second contact to make the introduction. The invitation may be sent via email, text message, instant message, or other communication schemes. The invitation may include contact information for the first or second contact so that the recipient contact can communicate to set up a meeting. The invitation may also include a photo and a name of the contact as well as a photo and name of the user who is making the introduction.

In some optional examples, the invitation may ask the contact to accept or reject the invitation. If both the first contact and the second contact accept the invitation to be introduced, the first contact's contact information is sent to the second contact and the second contact's contact information is sent to the first contact. If one or both of the first contact and the second contact reject or decline the invitation to be introduced, no contact information will be sent or exchanged.

In some alternative embodiments, the invitation may include digital currency for a particular vendor sent from the user. This may encourage the contacts to meet up at a particular vendor location. For example, the user may send digital currency (e.g., a Starbucks gift card) that can be spent at a coffee shop. The contacts are encouraged to use that digital currency to purchase coffee and meet at the coffee shop.

Additional messages may be generated by the software application at various times. For example, upon downloading the software application, a message may appear prompting the user to make an introduction. After making an introduction, the software application may generate a message praising the user and encouraging the user to make another introduction. For example, such a message could read “You just made someone's day! Which two people should you connect now?” The software application may also generate messages when a contact receives an introduction encouraging the contact to communicate with the other contact. For example, such a message might read “Reach out now and make a connection. Don't delay!”

The computing device 102 may include GPS and geo tagging capabilities. The software application could utilize those capabilities to geo tag users of the software application so that the users can determine if contacts made through the application are nearby (i.e., likely to be able to meet due to proximity).

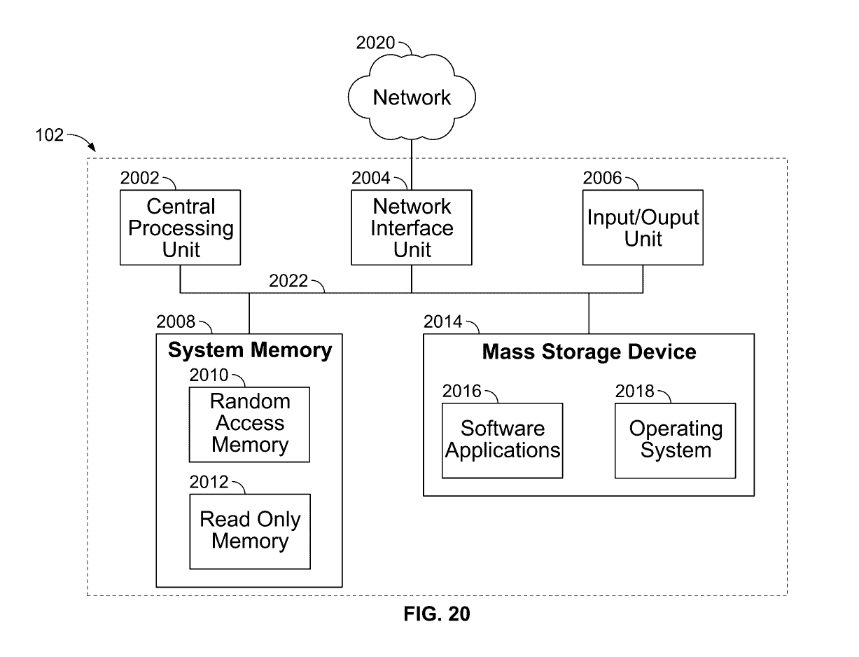

As illustrated in the example of FIG. 20, the computing device 102 includes at least one central processing unit (“CPU”) 2002, a system memory 2008, and a system bus 2022 that couples the system memory 2008 to the CPU 2002. The system memory 2008 includes a random access memory (“RAM”) 2010 and a read-only memory (“ROM”) 2012. A basic input/output system that contains the basic routines that help to transfer information between elements within the computing device 102, such as during startup, is stored in the ROM 2012. The computing device 102 further includes a mass storage device 2014. The mass storage device 2014 is able to store software instructions and data. A central processing unit, system memory and mass storage device similar to that in FIG. 20 are also included in application server computer 106.

The mass storage device 2014 is connected to the CPU 2002 through a mass storage controller (not shown) connected to the system bus 2022. The mass storage device 2014 and its associated computer-readable data storage media provide non-volatile, non-transitory storage for the computing device 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 102.

According to various embodiments of the invention, the computing device 102 may operate in a networked environment using logical connections to remote network devices through the network 104, such as a wireless network, the Internet, or another type of network. The computing device 102 may connect to the network 104 through a network interface unit 2004 connected to the system bus 2022. It should be appreciated that the network interface unit 2004 may also be utilized to connect to other types of networks and remote computing systems. The computing device 102 also includes an input/output controller 2006 for receiving and processing input from a number of other devices, including a touch user interface display screen, or another type of input device. Similarly, the input/output controller 2006 may provide output to a touch user interface display screen or other type of output device.

As mentioned briefly above, the mass storage device 2014 and the RAM 2010 of the computing device 102 can store software instructions and data. The software instructions include an operating system 2018 suitable for controlling the operation of the computing device 102. The mass storage device 2014 and/or the RAM 2010 also store software instructions, that when executed by the CPU 2002, cause the computing device 102 to provide the functionality of the computing device 102 discussed in this document. For example, the mass storage device 2014 and/or the RAM 2010 can store software instructions that, when executed by the CPU 2002, cause the computing device 102 to display received financial data on the display screen of the computing device 102.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of facilitating online introductions implemented on a computing device, the method comprising:
receiving, at the computing device, a selection from a user of a first contact and a second contact to create an introduction;
receiving a selection from the user of a relationship type for the introduction; and
sending an invitation to the first and second contacts to make the introduction.

2. The method of claim 1, further comprising:
connecting to one or more online accounts associated with the user; and
accessing a list of contacts and contact information from the online accounts.

3. The method of claim 2, wherein the online accounts comprise social networking accounts and email accounts.

4. The method of claim 1, further comprising receiving input from the user of contact information for the first contact and the second contact.

5. The method of claim 1, further comprising:
receiving an indication from both the first contact and the second contact to accept the introduction;
sending the first contact's contact information to the second contact; and
sending the second contact's contact information to the first contact.

6. The method of claim 1, further comprising setting up a profile for the user, wherein the profile includes the user's name and at least one of the following: an email address, a phone number, and a social networking account.

7. The method of claim 6, wherein the profile further comprises one or more of a photograph of the user, a website associated with the user, and preferences for the user, wherein the preferences include indicating whether the user wishes to be introduced to other users or prefers to only make introductions.

8. The method of claim 1, wherein the relationship type is one of a business relationship, a social relationship, and a romantic relationship.

9. The method of claim 1, wherein the sending comprises sending an email, text message, or instant message with the invitation to make the introduction.

10. A computing device, comprising:
a display;
a processor; and
memory encoding instructions that, when executed by the processor, cause the processor to:
access a plurality of contacts associated with an introducer;
allow for selection of two contacts to introduce;
allow for a definition of a relationship type between the two contacts; and
forward an introduction to each of the two contacts.

11. The device of claim 10, wherein the plurality of contacts is accessed by connecting to one or more online accounts associated with the introducer and obtaining a list of contacts and contact information from the online accounts.

12. The device of claim 10, wherein the introduction includes a name of one of the two contacts, a photograph of one of the two contacts, a name of the introducer, a photograph of the introducer, a personal message from the introducer, and a link to download an application.

13. The device of claim 10, wherein the instructions further cause the processor to forward each contact's contact information to the other contact upon receiving notice that each of the two contacts consents to being introduced.

14. The device of claim 13, wherein the contact information is presented with links to one of the two contact's social media profile, to open an email to one of the two contacts, to access a webpage of one of the two contacts, or to call one of the two contacts.

15. A system programmed to facilitate introductions, comprising:
a display;
a processor; and
memory, the memory including instructions that, when executed by the processor, create:
a profile module programmed to set up a profile for a user, wherein the profile comprises preferences for the user including indicating whether the user wishes to be introduced to other users or prefers to only make introductions;
a contacts module programmed to assemble a plurality of contacts associated with the user;
an introduction module programmed to receive a selection of two contacts to make an introduction and to receive a selection of a relationship type; and
a communication module programmed to communicate an invitation to the two contacts to make the introduction.

16. The system of claim 15, wherein the relationship type is one of a social relationship, a business relationship, and a romantic relationship.

17. The system of claim 15, wherein the communication module sends contact information of each contact to the other contact.

18. The system of claim 15, wherein the introduction module receives a selection to include digital currency for a particular vendor and the communication module sends the digital currency with the invitation.

19. The system of claim 15, wherein the communication module is further programmed to notify the user of successful and unsuccessful introductions.

20. The system of claim 15, wherein the profile module records introductions made by the user and connections to new contacts that the user made as a result of introductions made by other users.
